(19) United States
(12) Patent Application Publication
(10) Pub. No.: US 2009/0070034 A1
(43) Pub. Date: Mar. 12, 2009

(54) METHOD FOR RECORDING AN ANNOTATION AND MAKING IT AVAILABLE FOR LATER PLAYBACK

(76) Inventors: Christopher L Oesterling, Troy, MI (US); Jeffrey M Stefan, Clawson, MI (US)

Correspondence Address: General Motors Corporation;c/o REISING, ETHINGTON, BARNES, KISSELLE, P.C., P.O. BOX 4390, TROY, MI, 48099-4390, US

(21) Appl. No.: 11/276,896

(22) Filed: Mar. 17, 2006

(51) Int. Cl. G01C 21/00

(52) U.S. Cl. 701/209; 701/200; 701/208

(57) ABSTRACT

A method that is used with a vehicle navigation system and enables a driver or other vehicle occupant to record personalized information, such as verbal annotations, so that they may be automatically played back at a later time. When the voice annotations are recorded, the vehicle navigation system assigns them a location tag that indicates the place where they were recorded. Therefore, when that vehicle navigation system, or another navigation system installed on a different vehicle, comes within a certain proximity of the location identified by the location tag, the associated voice annotation is played back.

### TECHNICAL FIELD

The present invention relates generally to vehicle navigation systems and, more particularly, to vehicle navigation systems that allow a vehicle occupant to record an annotation or other personalized information and correlate that information to the location where it was recorded.

### BACKGROUND OF THE INVENTION

In recent years, GPS-based navigation systems have grown in popularity and are now widely available in a variety of forms, including different types of vehicle-installed units as well as hand-held portable units. These navigation systems are primarily based on a Global Positioning System (GPS) which was founded by the U.S. Department of Defense and consists of a constellation of 24 satellites working in conjunction with 5 base stations. The satellites orbit the Earth and transmit precise timing data to GPS receivers located on Earth. If strong signals from 3 or more satellites are received, then a latitude and longitude (two-dimensional) position can be determined; if strong signals from 4 or more satellites are received, then a latitude, longitude and altitude (three-dimensional) position can be calculated. Moreover, the accuracy of these navigation systems can be increased through the use of the Wide Area Augmentation System (WAAS), which monitors the satellite data through a collection of base stations and makes signal corrections to provide even more accurate position data.

The success and popularity of vehicle navigation systems has resulted in the development and sale of many different types of systems. For instance, one type of vehicle navigation system currently available is based on telematics. In general, telematics-based vehicle navigation systems utilize a combination of wireless voice and data technologies to communicate between vehicle-installed hardware and a back-end system in order to provide a number of different navigation-related services including turn-by-turn (TBT) spoken directions. In telematics-based systems such as these, the GPS-derived position of the vehicle is used in conjunction with road-data provided by the back-end system. The road data not only includes detailed maps of the area(s) in question, but also includes information pertaining to things such as average travel speed classifications, one way streets, highway exit/entrance ramp details, etc. and because the road data is maintained and provided by the back-end system, it is easily and frequently updated. Of course, the vehicle telematics system is typically capable of performing additional, non-navigation related tasks such as those related to providing entertainment, diagnostic or safety functions.

Another type of vehicle navigation system is an autonomous vehicle navigation system mounted on-board the vehicle. These systems use road data that is stored locally at the vehicle such as on a CD or DVD. In this example, the autonomous navigation system compares the position data gathered by the GPS receiver with the road data obtained from the CD or DVD, and the system can then use this information to provide a graphical display at the instrument panel showing a map with the vehicle location. With autonomous systems, there is no need to build and maintain a back-end system for supporting the vehicle navigation system.

### SUMMARY OF THE INVENTION

According to one aspect of the present invention, there is provided a method for capturing annotations provided by a vehicle occupant and making them available for later playback. The method includes the steps: (a) recording an annotation that pertains to a selected location; (b) generating a location tag that indicates the position of the selected location; (c) saving the annotation and the location tag, and (d) automatically playing back the annotation if the selected location is encountered again.

According to another aspect of the present invention, there is provided a method for capturing verbal annotations spoken by a vehicle occupant and making them available for later playback. This method includes the steps: (a) using a microphone to record a verbal annotation that pertains to a selected location; (b) using a GPS-based vehicle navigation system to generate a location tag that indicates the position of the selected location; (c) saving the verbal annotation and the location tag as electronic files, and (d) automatically playing back the annotation over a speaker when the vehicle navigation system determines that it is within a predetermined proximity of the selected location.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is a block diagram depicting an exemplary embodiment of a communications system that is capable of utilizing the disclosed method, and;

FIG. 2 is a flowchart demonstrating an embodiment of the disclosed method where a vehicle occupant is able to record annotations or other personalized information for later playback.

### DETAILED DESCRIPTION OF THE PREFERRED EMBODIMENTS

The disclosed method is used in conjunction with a vehicle navigation system and enables a driver or other vehicle occupant to record personalized information, such as verbal annotations, so that they may be automatically played back at a later time. When the voice annotations or comments are recorded, the vehicle navigation system assigns them a location tag that indicates the place where they were recorded. Therefore, when that vehicle navigation system, or another navigation system installed on a different vehicle, comes within a certain proximity of the location identified by the location tag, the associated voice annotation is played back.

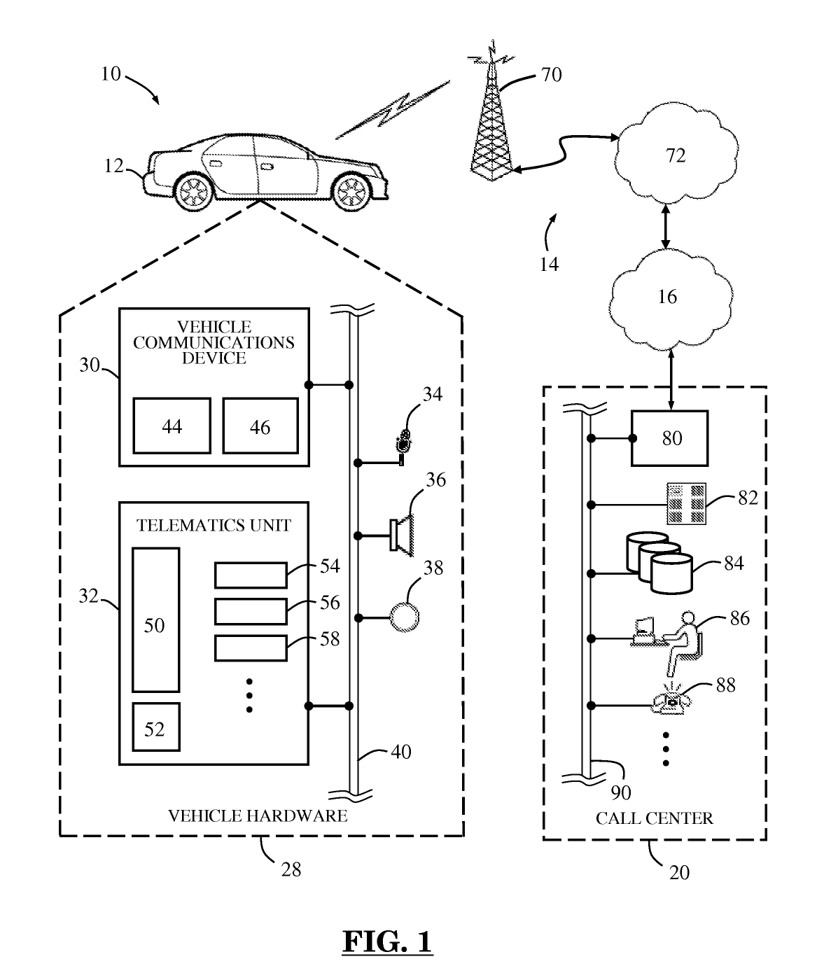

With reference to FIG. 1, there is shown an example of a communication system 10 that may be used with the disclosed method and generally includes a vehicle 12, a wireless carrier system 14, a land network 16, and a call center 20. It should be appreciated that the overall architecture, setup and operation, as well as the individual components, of a system such as that shown here are generally known in the art. Thus, the following paragraphs simply provide a brief overview of one such exemplary communication system 10, however, other systems not shown here could employ the disclosed method as well.

Vehicle 12 is preferably a mobile vehicle such as a motorcycle, car, truck, recreational vehicle (RV), boat, plane, etc., and is equipped with suitable hardware and software that enables it to communicate over system 10. Some of the vehicle hardware 28 is shown generally in FIG. 1 and includes a vehicle communication device 30, a telematics unit 32, a microphone 34, a speaker 36 and buttons and/or controls 38 that are interconnected using a network connection or bus 40. Examples of suitable network connections include a controller area network (CAN), a media oriented system transfer (MOST), a local interconnection network (LIN), an ethernet, and other appropriate connections such as those that conform with known ISO, SAE and IEEE standards and specifications, to name but a few.

Vehicle communication device 30 preferably uses radio transmissions to establish a voice channel with wireless carrier system 14 so that both voice and data transmissions can be sent and received over the voice channel. By providing both voice and data communication, vehicle communication device 30 enables the vehicle to offer a number of different services including those related to navigation, telephony, emergency assistance, diagnostics, infotainment, etc. According to one embodiment, vehicle communication device 30 includes a standard cellular chipset 44 for voice communications and a modem 46 for data transmission. In order to enable successful data transmission over the voice channel, modem 46 applies some type of encoding or modulation to convert the digital data so that it can communicate through a vocoder or speech codec incorporated in chipset 44. Any suitable encoding or modulation technique that provides an acceptable data rate and bit error rate can be used with the disclosed method. For a more complete discussion of an example of data transmission over a voice channel, please refer to U.S. patent application Ser. No. 11/163,579 filed Oct. 24, 2005, which is assigned to the present assignee and is hereby incorporated by reference.

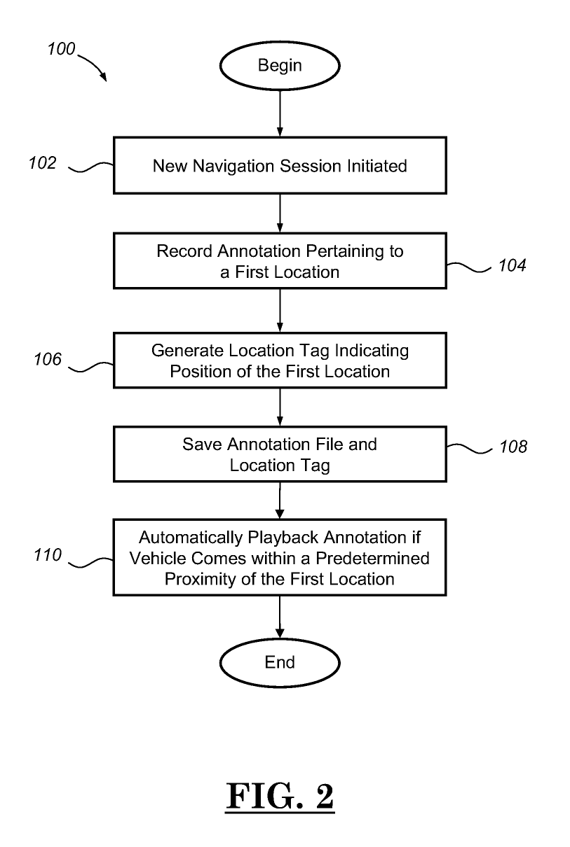

The telematics unit 32 is an onboard device that provides a variety of services through its communication with call center 20, and generally includes an electronic processing device 50, one or more types of electronic memory 52 and a number of function-specific devices or modules 54-58. The telematics unit 32 provides a variety of different services including, for example: turn-by-turn directions and other navigation-related services provided in conjunction with a GPS-based vehicle navigation unit 54; airbag deployment notification and other emergency or roadside assistance-related services provided in connection with various sensors 56 located throughout the vehicle; and infotainment-related services where music, webpages, movies, television programs, videogames and/or other information is downloaded by an infotainment center 58 and stored for current or later playback. The above-listed services are by no means an exhaustive list of all of the capabilities of telematics unit 32, as should be appreciated by those skilled in the art, but are simply an illustration of some of the services that the telematics unit is capable of offering. It is anticipated that telematics unit 32 will include a number of known components in addition to those listed above. The construction and operation of a suitable vehicle mounted telematics unit that can provide the above-identified services and that can be used to implement the method of FIG. 2 is known to those skilled in the art.

Microphone 34 provides the driver or other vehicle occupant with a means for inputting verbal or other auditory commands, and can be equipped with an embedded voice processing unit utilizing human/machine interface (HMI) technology known in the art. Conversely, speaker 36 provides verbal output to the vehicle occupants and can either be a stand-alone speaker specifically dedicated for use with telematics unit 32 or it can be part of the vehicle audio system. In either event, microphone 34 and speaker 36 enable vehicle hardware 28 and call center 20 to communicate with the occupants through audible speech. The vehicle hardware also includes one or more buttons or controls 38 for enabling a vehicle occupant to activate or engage one or more of the vehicle hardware components 28. For instance, button 38 can be an electronic push-button used to initiate voice communication with call center 20.

Wireless carrier system 14 is preferably a cellular telephone system or any other suitable wireless system that transmits signals between the vehicle hardware 28 and land network 16. According to an exemplary embodiment, wireless carrier system 14 includes one or more cell towers 70, base stations and/or mobile switching centers (MSCs) 72, as well as any other networking components required to connect the wireless system 14 with land network 16. As is appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements. Preferably, a speech codec or vocoder is incorporated in one or more of the base stations, but depending on the particular architecture of the wireless network, it could be incorporated within a mobile switching center (MSC) or some other network component as well.

Land network 16 can be a conventional land-based telecommunications network that is connected to one or more landline telephones and connects wireless carrier network 14 to call center 20. For example, land network 16 can include a public switched telephone network (PSTN) and/or an Internet Protocol (IP) network, as is appreciated by those skilled in the art. Of course, one or more segments of land network 16 could be implemented through the use of a standard wired network, a fiber or other optical network, a cable network, power lines, other wireless networks such as wireless local area networks (WLANs) or networks providing broadband wireless access (BWA), or any combination thereof. Furthermore, call center 20 need not be connected via land network 16, but could include wireless telephony equipment so that it can communicate directly with wireless network 14.

Call center 20 is designed to provide the vehicle hardware 28 with a number of different system back-end functions and, according to the exemplary embodiment shown here, generally includes one or more switches 80, servers 82, databases 84, live advisors 86, as well as a variety of other telecommunication and computer equipment 88 that is known to those skilled in the art. These various call center components are preferably coupled to one another via a wired or wireless local area network 90. Switch 80, which can be a private branch exchange (PBX) switch, routes incoming signals so that voice transmissions are usually sent to either the live adviser 86 or an automated response system, and data transmissions are passed on to a modem or other piece of equipment 88 for demodulation and further signal processing. The modem preferably includes an encoder, as previously explained, and can be connected to various devices such as a server 82 and database 84. Database 84 could be designed to store subscriber profile records, subscriber behavioral patterns, or any other pertinent subscriber information. Although the illustrated embodiment has been described as it would be used in conjunction with a manned call center 20, it will be appreciated that the call center can utilize an unmanned automated call response system and, in general, can be any central or remote facility, manned or unmanned, mobile or fixed, to or from which it is desirable to exchange voice and data transmissions.

Turning now to FIG. 2, there is shown a flowchart demonstrating an embodiment of the disclosed method where a driver or other vehicle occupant is able to record annotations so that they are available for later playback. Each annotation is assigned a GPS-derived location tag that indicates the location where it was recorded, thus enabling the annotation to be subsequently played back when the vehicle is within a certain proximity of that location. It should be appreciated that the term “annotation”, as used herein, broadly includes all types comments, observations, statements, questions and other personalized information that a vehicle occupant may want to record; this includes annotations provided by the vehicle occupant in the form of verbal speech, as well as those provided via some type of input device, such as a keyboard, a touch-screen or other graphical user interface (GUI), mouse, electronic controls, etc., as will be explained more thoroughly below.

According to the embodiment shown here, method 100 begins when a new navigation session is initiated, step 102. The vehicle navigation system 54 shown in FIG. 1 is a telematics-based navigation system; that is, onboard navigation system 54 communicates and works in conjunction with remote call center 20 in order to provide a variety of navigation-related services. It should be appreciated, however, that method 100 also works with independent navigation systems, such as those that use CDs, DVDs or other forms of locally stored information in order to provide navigation-related services without the assistance of a separate call center.

During vehicle operation, an occupant may observe something and want to make a note of it, at which point they activate a recording device and record an annotation, step 104. For instance, if one is driving down the highway and is looking for ‘Exit 43a’ and notices that the exit sign is missing, they may want to make a note of the missing sign.

Or, as another example, a vehicle occupant may be passing through a city and want to record, “on the Southeast corner of Main and 3rd there is a stand that sells the best hotdogs.” There are, of course, an infinite number of annotations and personalized information that an occupant may want to record, including information related to directions, points-of-interest, little known short-cuts, etc., and the above-recited examples are only meant to serve as exemplary illustrations. According to a preferred embodiment, the annotations include verbal comments that are spoken by the vehicle occupant, recorded by microphone 34, and stored as a wave file (.wav) or as another type of appropriate digital audio file.

As mentioned above, the annotations could include non-verbal electronic comments inputted by the vehicle occupant. For example, the vehicle hardware 28 could include a graphical user interface (GUI) and some type of electronic input device such as a touch-screen, keyboard, mouse, or a connection for communicating with a laptop, PDA or cell phone, to name but a few of the possibilities. In this scenario, the vehicle occupant enters non-verbal annotations in the form of electronic comments that are captured by the electronic input device and stored as an electronic file. The name of the annotation file where the recorded annotations are saved, whether they be derived from verbal or non-verbal input, can either be provided by the occupant, such as “missing exit sign”, or it can be a default name generated by the vehicle hardware 28.

In order to document the location where the annotation was recorded, vehicle navigation system 54 generates a location tag, step 106. The location tag is preferably an electronic file created just before, during or just after the time of recordation and includes location information, such as the GPS-derived longitude and latitude coordinates of the place where the annotation was recorded. For instance, if a driver is driving to work and notices a particularly large pothole in the far left lane and wants to make an annotation so as to avoid the pothole the next day, they could record a verbal comment regarding the pothole and the vehicle navigation system would generate a location tag that includes the coordinates (42° 30′ N, 83° W), for example. In this manner, the vehicle hardware 28 will be able to playback the warning captured in the annotation the next time the vehicle navigation system 54 determines that they are within a certain proximity of the pothole, as will be subsequently described in more detail. The contents of the annotation file, whether it be a digital audio file or other electronic file, and the location tag may be combined and saved as a single electronic file, or they could be saved as separate files so long as they were somehow associated with one another, step 108. Stated differently, the annotation file and location tag should be correlated to one another so that the vehicle hardware 28 knows which annotation file goes with which location tag.

The following description of step 110 is directed to an embodiment where the annotation file and location tag are saved on the same vehicle hardware 28 that generated those files initially; that is, the annotation and location tag files are not transmitted to other vehicles. As will be subsequently explained, however, it is possible for the annotation and location tag files to be sent to other vehicles so that they may use them as well. Once the annotation and location tag files have been saved, the vehicle hardware 28 waits until the next time that vehicle navigation system 54 indicates that it is within a predetermined proximity of the position identified by the location tag. For instance, in the pothole example above, a location tag was saved that included the coordinates 42° 30′ N, 83° W. The next time navigation system 54 determines that it is within say 100 m of those coordinates, the vehicle hardware would automatically play back the recorded annotation which warned the driver of the particularly large pothole in the far left lane. In the case of annotations that include recorded verbal comments, the saved annotations could be played back to the occupants over one or more speakers connected to the vehicle hardware. If the annotations include non-verbal electronic comments entered via some type of input device as described above, then the annotations could be presented to the occupant via a GUI or some other type of appropriate device. Furthermore, it is possible for the vehicle hardware 28 to convert non-verbal annotations such that they are verbally played back to the occupants and vice-versa.

It should be recognized that the predetermined proximity that triggers playback of the recorded annotation could be adjusted by an occupant and/or the call center 20, or the proximity could be separately set each time an annotation is recorded in order to meet the particular needs of that annotation. For instance, the proximity in the pothole example may only be set to 100 m or so, as the driver would not want the proximity to be so large that the annotation could be triggered if they were driving on a separate, but nearby road. In the example of an annotation reminding a driver to avoid a large construction zone, the trigger proximity may be a mile or more in order to give the driver plenty of time to find an alternative route. Also, the recorded annotations could be saved so that they are only played back when the vehicle is traveling in a particular direction and/or speed. This way, a recorded annotation pertaining to a pothole in a South-bound lane is not triggered and played back when the vehicle is heading North-bound on the same highway.

It is also possible to adjust the moment when a location tag is generated. For instance, if the recorded annotations are primarily being used to identify and document various obstacles or features in the road, then the location tag generation process could be adjusted so that a new location tag is generated at the moment the occupant engages the record button; accordingly, the vehicle does not get too far away from the feature so as to not be helpful. The location tag could alternatively be generated when the occupant terminates or otherwise ends the recording process.

As briefly indicated above, the annotation and location tag files can be sent to other vehicles directly or through call center 20, so they too can enjoy the benefits of the saved annotation. For instance, if multiple vehicles were heading towards a common destination and a first vehicle realized that a certain detour would avoid major traffic congestion, then an occupant in that vehicle could record an annotation describing the detour, set a trigger proximity, and transfer the files to the other vehicles by entering phone numbers or other identifiers that uniquely identify those vehicles. This way, if any of the other vehicles are traveling a similar route where the annotation would be pertinent, as soon as they were within the predetermined proximity the annotation would be automatically played back so that it warned them of the traffic congestion and suggested the detour. Depending on the vehicle communications device 30 and the other vehicle hardware 28, the transferred annotations and location tags could be sent directly from vehicle-to-vehicle or they could be sent through call center 20.

According to another embodiment of the disclosed method, the vehicle hardware 28 saves the annotation and location tag as part of an automated route, such as those that provide turn-by-turn directions. For instance, suppose a vehicle occupant that is in a vehicle equipped with a telematics-based navigation system requests an automated route from call center 20 for driving from point A to point B. The vehicle hardware 28 downloads the route from the call center and begins displaying the route to the driver, as is known in the art. During the execution of the route, if an occupant determines that he or she would like to record an annotation, they perform the process described above. The annotation and location tag are saved, same as before, but they are incorporated into the automated route so that the entire route, complete with annotations, is available for subsequent playback. The next time the driver is going from point A to point B, the automated route can be pulled up and run so that each time the vehicle enters a new predetermined proximity, the corresponding annotation is played back. One difference between these two embodiments is that in the previous example that was described in conjunction with FIG. 2 the annotations were played back whenever a vehicle was within a certain proximity of the target location, where this embodiment only provides playback of the annotation if one is running the automated route with the embedded annotations.

It should be recognized that the automated route with embedded annotations can either be saved locally so that it is only available to that vehicle, or it can be sent to one or more other vehicles so that they too can playback the entire automated route, including the annotations, as described above. Furthermore, it should be recognized that this embodiment does not have to be used with a telematics-based vehicle navigation system, as provided in the illustrative example above, and can be used with an independent vehicle navigation system such as those previously described.

It is to be understood that the foregoing description is not a description of the invention itself, but of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method for capturing annotations provided by a vehicle occupant and making them available for later playback, comprising the steps:
(a) recording an annotation that pertains to a selected location;
(b) generating a location tag that indicates the position of the selected location;
(c) saving the annotation and the location tag, and;
(d) automatically playing back the annotation if the selected location is encountered again.

2. The method of claim 1, wherein step (a) further comprises recording an annotation that includes verbal comments that are spoken by a vehicle occupant, recorded by a microphone, and stored as a digital audio file.

3. The method of claim 1, wherein step (a) further comprises recording an annotation that includes electronic comments that are inputted by a vehicle occupant, captured by an electronic input device, and stored as an electronic file.

4. The method of claim 1, wherein step (b) further comprises generating a location tag that includes GPS-derived longitude and latitude coordinates provided by a vehicle navigation system.

5. The method of claim 1, wherein step (c) further comprises saving the annotation and the location tag in a manner that associates them to one another.

6. The method of claim 1, wherein step (d) further comprises automatically playing back the annotation only if a GPS-based vehicle navigation system comes within a predetermined proximity of the selected location.

7. The method of claim 6, wherein the predetermined proximity regarding the selected location can be adjusted by the vehicle occupant.

8. The method of claim 6, wherein the predetermined proximity regarding the selected location is affected by the direction in which the vehicle is heading.

9. The method of claim 6, wherein the predetermined proximity regarding the selected location is affected by the speed at which the vehicle is being driven.

10. The method of claim 1, wherein the recorded annotation includes a verbal comment that is played through one or more speakers.

11. The method of claim 1, wherein the annotation includes an electronic comment that is displayed by one or more graphical user interfaces.

12. The method of claim 1, wherein the method further comprises sending the annotation and the location tag to another vehicle, and playing back the annotation if that other vehicle comes within a predetermined proximity of the selected location.

13. The method of claim 1, wherein the method further comprises storing the annotation and the location tag at a remote location, and making it available to another vehicle via a wireless communications system.

14. The method of claim 1, wherein the method further comprises associating the annotation and the location tag with an automated route, and executing step (d) only if: (i) the selected location is encountered again, and ii) the automated route is being run.

15. A method for capturing verbal annotations spoken by a vehicle occupant and making them available for later playback, comprising the steps:
(a) using a microphone in the vehicle to record a verbal annotation that pertains to a selected location;
(b) using a GPS-based vehicle navigation system to generate a location tag that indicates the position of the selected location;
(c) saving the verbal annotation and the location tag as electronic files, and;
(d) automatically playing back the annotation over a speaker in the vehicle when the vehicle navigation system determines that it is within a predetermined proximity of the selected location.

16. The method of claim 15, wherein step (c) further comprises saving the annotation and the location tag in a manner that associates them to one another.

17. The method of claim 15, wherein the predetermined proximity regarding the selected location can be adjusted by the vehicle occupant.

18. The method of claim 15, wherein the method further comprises sending the annotation and the location tag to another vehicle, and playing back the annotation if that other vehicle comes within a predetermined proximity of the selected location.

19. The method of claim 15, wherein the method further comprises associating the annotation and the location tag with an automated route, and executing step (d) only if: (i) the selected location is encountered again, and ii) the automated route is being run.
